(19) United States
(12) Patent Application Publication
(10) Pub. No.: US 2015/0125701 A1
(43) Pub. Date: May 7, 2015

(54) COMPOSITE COMPONENT MADE OF PLASTIC

(71) Applicants: Dirk Kieslich, Plettenberg (DE); Binfeng Hu, Luedenscheid (DE)

(72) Inventors: Dirk Kieslich, Plettenberg (DE); Binfeng Hu, Luedenscheid (DE)

(73) Assignee: Automobile patentvewaltungs-und- verwertungsgesellschaft mbH, Luedenscheid (DE)

(21) Appl. No.: 14/398,007

(22) PCT Filed: Jul. 31, 2012
(86) PCT No.: PCT/EP2012/064922

§ 371 Date: Oct. 30, 2014

(30) Foreign Application Priority Data
May 14, 2012 (DE) 10 2012 104 187.3

(51) Int. Cl. B32B 25/08; B60R 13/02; B32B 25/16; B32B 27/32; B32B 27/34

(52) U.S. Cl. CPC B32B 25/08; B32B 27/325; B32B 27/34; B32B 25/16; B60R 13/02; B32B 2605/003
USPC 428/412; 428/476.3; 428/519; 428/517; 428/516

(57) ABSTRACT

A composite component made of plastic for decorative elements in the interior of motor vehicles consists of at least one support made of galvanizable plastic and at least one decorative insert made of galvanoresistant plastic, which is undetachably joined to the support. The galvanizable plastic of the support is an acrylonitrile-butadiene-styrene copolymer (ABS); the galvanoresistant plastic of the decorative insert is a cyclo-olefin copolymer (COC) or a polyamide 12 (PA 12).

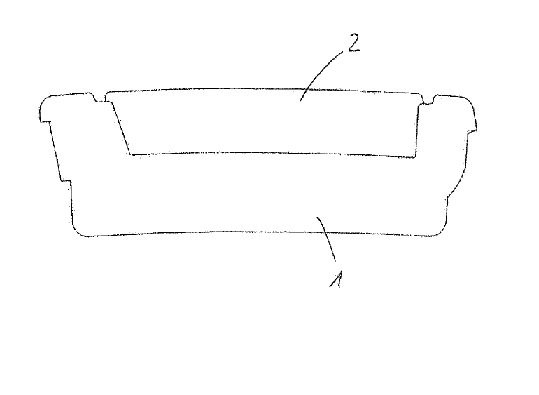

The invention relates to a composite component made of plastic, for decorative elements in the interior of motor vehicles, consisting of at least one support made of galvanizable plastic and at least one decorative insert made of galvanoresistant plastic, undetachably connected with the support.

Composite components of the type stated initially are known, for example, from DE 195 16 540 A1. Using these components, it is possible to produce plastic parts that have metallized surfaces in some regions, and with which the interior design of motor vehicle can therefore be influenced. In the case of the known component, polycarbonate (PC) is used as the galvanoresistant material, among other things. Until now, it was possible to meet the requirements of the automobile manufacturers with regard to the material properties for interior design of such components with this material. They were therefore suitable for being used as decorative elements, on the one hand, and on the other hand also for components that demonstrate what is called a day/night design, in order to allow recognizability of certain functional elements even in darkness.

Very recently, however, there has increasingly been a further requirement on the part of the automobile manufacturers, which the composite components for interior design of motor vehicles are supposed to meet, namely resistance to chemicals and skin cosmetics in general, as well as what is called the “sun lotion test” specifically. In this connection, the components are wetted with a lotion comparable to sun lotion. The components wetted in this manner are subsequently exposed to elevated temperatures for several hours. After cooling, the lotion is removed from the components and an evaluation takes place. In this connection, it has been shown that the metallized surfaces pass the sun lotion test without problems. However, the further parts of the composite components, which are produced from polycarbonate, fail this test. Parts made of polycarbonate are not able to meet the optical requirements of the automobile manufacturers, particularly with regard to brilliance of the surfaces.

It is therefore the task of the present invention to create a composite component made of plastic, for decorative elements in the interior of motor vehicles, which consists, on the one hand, of a support made of galvanizable plastic and, on the other hand, of a decorative insert made of galvanoresistant plastic, which satisfies the requirements of the sun lotion test in addition to the other requirements of the automobile manufacturers. According to the invention, this task is accomplished in that the galvanizable plastic of the support is an acrylonitrile-butadiene-styrene copolymer (ABS), and that the galvanoresistant plastic of the decorative insert is a cyclo-olefin copolymer (COC) or a polyamide 12 (PA 12).

With the invention, a composite element made of plastic, for decorative elements in the interior of motor vehicles, is created, which satisfies the requirements of the sun lotion test that is now increasingly being applied, in addition to the previous demands of the automobile industry for galvanoresistance of the decorative variant, adhesion of the decoration to the material to be galvanized, scratch resistance, as well as a very shiny surface. In this way, the possibility is created, also for the future, of making available composite components made of plastic, for the interior of motor vehicles, with surfaces that are metallized in certain regions. In this way, it is possible to continue doing without the multipart configuration of the components, in which a galvanized plastic part is connected, with force fit or shape fit, with a non-galvanized plastic part, so that no additional assembly work steps are required. The configuration of composite components for the exterior region of motor vehicles is not affected by this, because these are not subjected to the sun lotion test, but must demonstrate increased UV protection.

Cyclo-olefin copolymers (COC) are technical polymers. They are amorphous and therefore transparent. Furthermore, the cyclo-olefin copolymers (COC) demonstrate great rigidity, strength, and hardness. Alternatively, a polyamide 12 (PA 12) can be used as a galvanoresistant component. This is an amorphous, non-polar polyamide, which demonstrates low density, great wear resistance, and impact resistance.

In a further development of the invention, the galvanizable plastic of the support is mixed with polyolefins. An improvement in the adhesion between the galvanizable and the galvanoresistant plastic is brought about by mixing in polyolefins.

Preferably, the proportion of polyolefins in the galvanizable plastic of the support lies between 5% and 30%; extremely preferably, the proportion amounts to 10%.

In another further development of the invention, the galvanoresistant plastic of the decorative insert is mixed with polyolefins. The adhesion of the galvanoresistant plastic to the galvanizable plastic of the support is also additionally improved by mixing in the polyolefins.

It is advantageous if the proportion of polyolefin in the galvanoresistant plastic of the decorative insert lies between 5% and 40%; preferably, the proportion amounts to 20%.

Other further developments and embodiments of the invention are indicated in the remaining dependent claims. An exemplary embodiment of the invention is shown in the drawing and will be described in detail below. The sole figure of the drawing shows the cross-section through a composite component according to the invention, in the form of a decorative strip for the interior of a motor vehicle.

The composite component made of plastic, selected as the exemplary embodiment, is intended for use as a decorative element in the interior of motor vehicles. As an example, it consists of a support 1 made of galvanizable plastic. A decorative insert 2 is connected with the support 1. The decorative insert 2 consists of galvanoresistant plastic. In a modification of the exemplary embodiment, multiple decorative inserts 2 can also be connected with the support 1. The connection between the support 1 and the decorative insert 2 takes place with material fit and is therefore not releasable.

The galvanizable plastic of the support is an acrylonitrile-butadiene-styrene copolymer (ABS). In the exemplary embodiment, the galvanizable plastic of the support 1 is provided with proportions of polycarbonate (PC). The galvanizable plastic of the support 1 is mixed with polyolefins, preferably with polypropylene (PP). The proportion of the polyolefins lies between 5% and 30%. Studies have shown that the best material properties can be achieved if the proportion of polyolefins in the galvanizable plastic of the support amounts to 10%.

The galvanoresistant plastic of the decorative insert 2 is a cyclo-olefin copolymer (COC). In the exemplary embodiment, the galvanoresistant plastic of the decorative insert 2 is also mixed with polyolefins. According to the invention, the proportion of polyolefins in the galvanoresistant plastic of the decorative insert 2 lies between 5% and 40%. In this connection, a proportion of 20% polyolefins in the galvanoresistant plastic is preferred, according to the invention.

The production of the composite component according to the invention takes place using the injection-molding method, so that in the case of the exemplary embodiment, the component according to the invention can be produced by means of a two-component injection-molding method. After injection-molding, the component is created, ready for assembly, in terms of its basic shape, by means of the material-fit connection of the support with the decorative insert. Subsequently, only galvanization takes place, whereby the galvanization can take place in part or entirely on the support 1. In general, for cost reasons, partial galvanization will take place, so that only the visible side of the support 1 of the composite component, in each instance, has a metallized surface.

On the basis of the galvanoresistant configuration of the decorative insert 2 in the exemplary embodiment, the surface of the decorative insert 2 is unchanged after galvanization has taken place. Because of the galvanoresistance of the decorative insert 2, damage during the galvanization process is precluded. Instead, it is possible to make a black surface, or a surface of a different color, with great shine, available even after the galvanic process. As a result, the very great optical demands in the interior of automobiles are satisfied. At the same time, the composite component according to the invention also meets all the other demands in the automobile industry. Thus, reliable adhesion of the galvanic coating on the support 1 is guaranteed on the basis of the plastic selected. At the same time, the material is scratch-resistant. Furthermore, the production of a very shiny surface of the decorative insert 2 that is not galvanically coated is possible.

However, it is essential to the invention that the composite component passes the tests that have recently come into use, particularly the sun lotion test, without damage not only to the galvanic layer but also to the surface of the decorative insert. This is achieved by means of the use, according to the invention, of cyclo-olefin copolymer (COC) or polyamide 12 (PA 12) as the galvanoresistant plastic for the decorative insert. In this connection, it should be noted that polyamide 12 (PA 12) does not enter into adhesion with the support material to be galvanized, under normal processing conditions, so that special treatment is necessary. Here, treatment of the support material with a plasma beam has proven to be particularly suitable. In this connection, the surface of the component to be coated, here the support 1, is plasma-treated with an active gas, leading to breakup of the bonds close to the surface in the plastic, in order to obtain an activated, polar surface, thereby making adhesion of the materials possible.

Comprehensive studies have shown that cyclo-olefin copolymer (COC) and polyamide 12 (PA 12) meet the previous quality requirements of the automobile manufacturers, and also pass the sun lotion test, which the previous materials fail. On the basis of the selected material combination, particularly by mixing polyolefins, particularly polypropylene (PP), into the galvanizable plastic of the support 1 and/or into the galvanoresistant plastic of the decorative insert 2, the adhesion of the two materials used is furthermore excellent, so that here, too, the previously known results of the material components used in the state of the art can be achieved.

Polypropylene (PP) is particularly suitable, in this connection, because it is related, in terms of type, to the cyclo-olefin copolymer (COC), which was catalyzed chemically by means of a particular polymerization method, and is chemically a polypropylene, in the actual sense.

Other polyolefins can also be used as “adhesion-mediating agents” between ABS and COC, such as polyethylene (PE) or polystyrene (PS). By mixing mineral into the component to be galvanized, the mechanical properties of the ABS and of the PP can furthermore be improved.

The adhesion of the galvanoresistant plastic is of decisive importance for the decorative insert, because in the case of insufficient adhesion, penetration of electrolytes can occur during the galvanic process, which in turn wash out during the continuing process of galvanization and lead to open places in the regions to be galvanized. With the component proposed according to the invention, adhesion is guaranteed and breakup is successfully counteracted.

1. Composite component made of plastic, for decorative elements in the interior of motor vehicles, comprising at least one support (1) made of galvanizable plastic and at least one decorative insert (2) made of galvanoresistant plastic undetachably connected with the support (1), wherein the galvanizable plastic of the support (1) is an acrylonitrile-butadiene-styrene copolymer (ABS), and wherein the galvanoresistant plastic of the decorative insert (2) is a cyclo-olefin copolymer (COC) or a polyamide 12 (PA 12).

2. Component according to claim 1, wherein the galvanizable plastic of the support (1) is an acrylonitrile-butadiene-styrene copolymer (ABS) provided with proportions of polycarbonate (PC).

3. Component according to claim 1, wherein the galvanizable plastic of the support (1) is mixed with polyolefins.

4. Component according to claim 3, wherein the proportion of polyolefin in the galvanizable plastic of the support (1) lies between 5% and 30%.

5. Component according to claim 3, wherein the proportion of polyolefin in the galvanizable plastic of the support (1) amounts to 10%.

6. Component according to claim 1, wherein the galvanoresistant plastic of the decorative insert (2) is mixed with polyolefin.

7. Component according to claim 6, wherein the proportion of polyolefin in the galvanoresistant plastic of the decorative insert (2) lies between 5% and 40%.

8. Component according to claim 6, wherein the proportion of polyolefin in the galvanoresistant plastic amounts to 20%.

9. Component according to claim 1, wherein the polyolefin is a polypropylene (PP).

10. Component according to claim 1, wherein the support (1) is plasma-treated in the region to be coated.
